(19) United States
(12) Patent Application Publication
(10) Pub. No.: US 2021/0334235 A1
(43) Pub. Date: Oct. 28, 2021

(54) SYSTEMS AND METHODS FOR CONFIGURING, CREATING, AND MODIFYING PARALLEL FILE SYSTEMS

(71) Applicant: NetApp, Inc., Sunnyvale, CA (US)

(72) Inventors: Eric Weber, Wichita, KS (US); Jason Eastburn, Wichita, KS (US); Jason Hennessy, Wichita, KS (US)

(21) Appl. No.: 16/856,809

(22) Filed: Apr. 23, 2020

(51) Int. Cl. G06F 16/11; G06F 16/182

(52) U.S. Cl. CPC G06F 16/11; G06F 16/182

(57) ABSTRACT

A method, a computing device, and a non-transitory machine-readable medium for allocating configuring, creating, and modifying parallel file systems are disclosed. In one or more example embodiments, a file system object that identifies a set of parameters (e.g., name, capacity, subnetwork, subnetwork partition, etc.) for a parallel file system is received at an orchestration engine from a service. In response to detecting the presence of the file system object, a controller of the orchestration engine creates a set of orchestration objects based on the set of parameters. The orchestration engine then configures a container structure based on the set of orchestration objects. The container structure may include a container for running a file system service for the parallel file system. The orchestration engine mounts a set of volumes in a distributed storage system to the container structure for use in running the parallel file system.

### TECHNICAL FIELD

The present description relates to parallel file systems, and more specifically, to systems and methods for automating the configuration and management of parallel file systems.

### BACKGROUND

A parallel file system is a type of clustered file system that enables data that is stored across multiple storage nodes (e.g., storage arrays) to be accessed via multiple server nodes (e.g., physical servers) that are networked. For example, one server node may access the data stored on multiple storage nodes simultaneously. As another example, multiple server nodes may access the data stored on a single storage node simultaneously. Parallel file systems facilitate efficient data access by enabling coordinated input/output operations between clients and storage nodes in a manner that may enable redundancy and improve performance.

While some currently available parallel file systems support running multiple file systems simultaneously on the same cluster of storage nodes, these parallel file systems are not intended for use by multiple customers representing multiple business entities (e.g., organizations). For example, currently available parallel file systems offer little to no logical separation between file systems, making storing data from multiple customers on a same server less secure than desired, and resulting in file system services competing for memory and computing resources. Further, currently available parallel file systems may be unable to provide a desired level of high availability. A highly available system is one that is able to consistently provide a predetermined level of operational performance (e.g., at least 98% or 99% uptime). A highly available system also provides redundancy to help accommodate points of failure. However, some currently available options for providing high availability with parallel file systems are limited in that that they require more storage capacity than desired and require that a customer have more specialized knowledge than he or she has or wants with respect to the underlying storage architecture.

### BRIEF DESCRIPTION OF THE DRAWINGS

The present disclosure is best understood from the following detailed description when read with the accompanying figures.

FIG. 1 is an illustration of a computing architecture in accordance with one or more example embodiments.

FIG. 2 is a schematic diagram illustrating an orchestration engine of the computing architecture from FIG. 1 in greater detail, in accordance with one or more example embodiments.

FIG. 3 is a schematic diagram of the computing architecture in accordance with one or more example embodiments.

FIG. 4 is a flow diagram of a process for creating and/or modifying a parallel file system in accordance with one or more example embodiments.

FIG. 5 is a flow diagram of a process for creating a parallel file system in accordance with one or more example embodiments.

### DETAILED DESCRIPTION

All examples and illustrative references are non-limiting and should not be used to limit the claims to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

Various embodiments include systems, methods, and machine-readable media for automatically configuring, creating, and/or modifying parallel file systems using an orchestration engine based on a set of parameters. The set of parameters may be provided by an end user, a service, or a program or obtained from a database or list of parameters. The orchestration engine runs on a distributed server node system. In one or more example embodiments, the orchestration engine includes a controller that monitors an application programming interface (API) server of the orchestration engine. For example, the controller may monitor the API server and wait to detect the presence of a file system object. The new file system object may include, for example, a request to create or modify a parallel file system and a set of parameters for the parallel file system. The set of parameters may include basic parameters such as, for example, at least one of a name, a capacity, a subnetwork, a subnetwork partition, or some other parameter for the parallel file system.

The file system object detected by the controller may have arrived at the API server in different ways. As one example, a request service may generate a file system request based on one or more parameters provided by an end user. The request service may then send the file system request to an object service that reads and translates the file system request to create and write a file system object onto the API server of the orchestration engine. This file system object may identify the set of parameters, such as those described above. In some examples, the set of parameters includes the one or more parameters provided by the end user. In other examples, the set of parameters additionally includes another one or more parameters provided by the object service. In response to detecting the file system object on the API server, the controller automatically creates a set of orchestration objects based on the set of parameters.

The orchestration engine configures a container structure based on the set of orchestration objects. The container structure may include one or more containers. A container may include a service that holds a running application, libraries, and their dependencies. The container structure is assigned to a worker node (e.g., a physical server) associated with the orchestration engine. In some examples, a container structure includes a single container for running a single file system service for the parallel file system. This file system service may be, for example, a management service, a metadata service, or a storage service. The orchestration engine mounts a set of volumes in a distributed storage system to the worker node with the container structure. The orchestration engine can then provide an end user with indirect access to the data in the set of volumes mounted to the container structure over a network via a client. For example, the client may be a parallel file system client that can indirectly access the data in the set of volumes via the container structure by communicating with the container structure over a cloud-based network. Any number of container structures may be configured in a manner similar to that described above for the parallel file system. In other words, a parallel file system may be run using one or more container structures.

The systems, methods, and machine-readable media for implementing these types of parallel file systems within a computing architecture are described in further detail in the following disclosure. The type of computing architecture described below helps reduce the amount of time and computing resources that would be otherwise needed to provide efficient and highly-available parallel file systems that are tuned to the specific needs of an end user and allow for multi-tenancy solutions. Further, the computing architecture described below significantly reduces the amount of specialized knowledge that an end user needs in order to configure and setup a parallel file system that uses container structures. For example, the end user can quickly create a parallel file system by providing no more than a few (e.g., one, two, three, four, or five) parameters. The orchestration engine running on a distributed server node system in the computing architecture configures and creates a parallel file system with file system services that are run in containers based on these parameters and without requiring any additional input from the user. For example, one or more algorithms may be used to automatically fill out templates based on the user-provided input.

This type of process may reduce the overall time and computing resources needed to create an efficient parallel file system specifically and accurately tuned to the needs of the end user. Further, the computing architecture described below allows for the efficient isolation of access to parallel file systems for different customers to different subnetworks or subnetwork partitions, thereby providing multi-tenancy solutions. Accordingly, the embodiments described herein provide advantages to computing efficiency and allow the use of computing resources to be maximized to provide the greatest benefit.

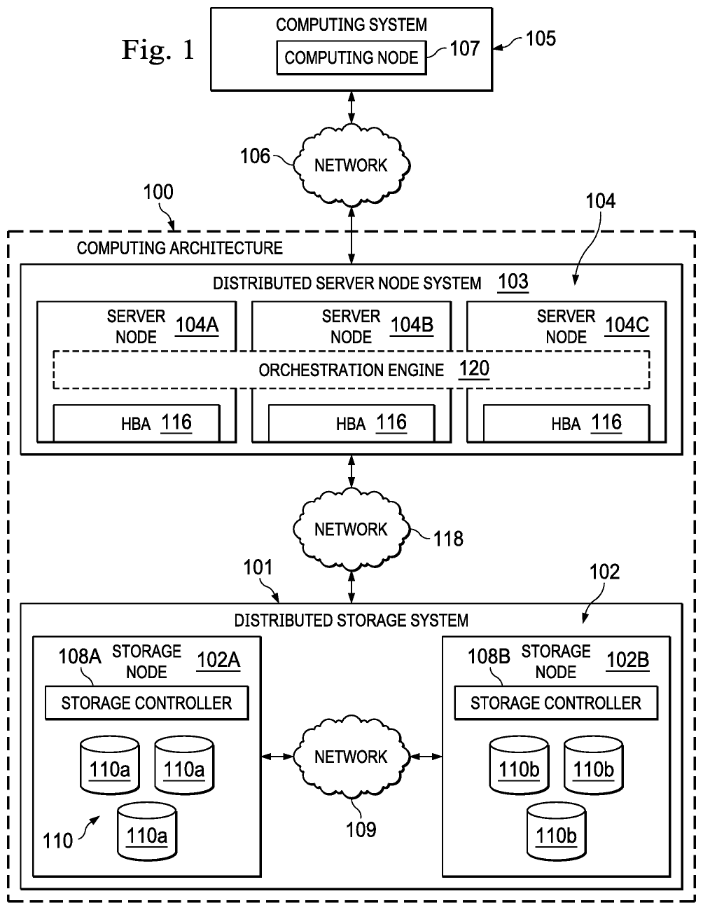

FIG. 1 is an illustration of a computing architecture 100 in accordance with one or more example embodiments. The computing architecture 100, which, in some cases includes a distributed storage system 101 comprising a number of storage nodes 102 (e.g., storage node 102a, storage node 102b) in communication with a distributed server node system 103 comprising a number of server nodes 104 (e.g., server node 104a, server node 104b, server node 104c). A computing system 105 communicates with the computing architecture 100, and in particular, the distributed server node system 103, via a network 106. The network 106 may include any number of wired communications links, wireless communications links, optical communications links, or combination thereof. In one or more examples, the network 106 includes at least one of a Local Area Network (LAN), an Ethernet subnet, a PCI or PCIe subnet, a switched PCIe subnet, a Wide Area Network (WAN), a Metropolitan Area Network (MAN), the Internet, or some other type of network.

The computing system 105 may include, for example, at least one computing node 107. The computing node 107 may be implemented using hardware, software, firmware, or a combination thereof. In one or more other examples, the computing node 107 is a client (or client service) and the computing system 105 that the client runs on is, for example, a physical server, a workstation, etc.

The storage nodes 102 may be coupled via a network 109, which may include any number of wired communications links, wireless communications links, optical communications links, or a combination thereof. For example, the network 109 may include any number of wired or wireless networks such as a LAN, an Ethernet subnet, a PCI or PCIe subnet, a switched PCIe subnet, a WAN, a MAN, a storage area network (SAN), the Internet, or the like. In some embodiments, the network 109 may use a transmission control protocol/Internet protocol (TCP/IP), a remote direct memory access (RDMA) protocol (e.g., Infiniband®, RDMA over Converged Ethernet (RoCE) protocol (e.g., RoCEv1, RoCEv2), iWARP), and/or another type of protocol. Network 109 may be local or remote with respect to a rack or datacenter. Additionally, or in the alternative, the network 109 may extend between sites in a WAN configuration or be a virtual network extending throughout a cloud. Thus, the storage nodes 102 may be as physically close or widely dispersed as needed depending on the application of use. In some examples, the storage nodes 102 are housed in the same racks. In other examples, the storage nodes 102 are located in different facilities at different sites around the world. The distribution and arrangement of the storage nodes 102 may be determined based on cost, fault tolerance, network infrastructure, geography of the server nodes 104, another consideration, or a combination thereof.

The distributed storage system 101 processes data transactions on behalf of other computing systems such as, for example, the one or more server nodes 104. The distributed storage system 101 may receive data transactions from one or more of the server nodes 104 and take an action such as reading, writing, or otherwise accessing the requested data. These data transactions may include server node read requests to read data from the distributed storage system 101 and/or server node write requests to write data to the distributed storage system 101. For example, in response to a request from one of the server nodes 104a, 104b, or 104c, one or more of the storage nodes 102 of the distributed storage system 101 may return requested data, a status indictor, some other type of requested information, or a combination thereof, to the requesting server node. While two storage nodes 102a and 102b and three server nodes 104a, 104b, and 104c are shown in FIG. 1, it is understood that any number of server nodes 104 may be in communication with any number of storage nodes 102. A request received from a server node, such as one of the server nodes 104a, 104b, or 104c may originate from, for example, the computing node 107 (e.g., a client service implemented within the computing node 107) or may be generated in response to a request received from the computing node 107 (e.g., a client service implemented within the computing node 107).

While each of the server nodes 104 and each of the storage nodes 102 is referred to as a singular entity, a server node (e.g., server node 104a, server node 104b, or server node 104c) or a storage node (e.g., storage node 102a, or storage node 102b) may be implemented on any number of computing devices ranging from a single computing system to a cluster of computing systems in communication with each other. In one or more examples, one or more of the server nodes 104 may be run on a single computing system, which includes at least one processor such as a microcontroller or a central processing unit (CPU) operable to perform various computing instructions that are stored in at least one memory. In one or more examples, at least one of the server nodes 104 and at least one of the storage nodes 102 reads and executes computer readable code to perform the methods described further herein to orchestrate parallel file systems. The instructions may, when executed by one or more processors, cause the one or more processors to perform various operations described herein in connection with examples of the present disclosure. Instructions may also be referred to as code. The terms “instructions” and “code” may include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

A processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); at least one network interface such as an Ethernet interface, a wireless interface (e.g., IEEE 802.11 or other suitable standard), a SAN interface, a Fibre Channel interface, an Infiniband® interface, or any other suitable wired or wireless communication interface; and/or a user I/O interface coupled to one or more user I/O devices such as a keyboard, mouse, pointing device, or touchscreen.

In one or more examples, each of the storage nodes 102 contains any number of storage devices 110 for storing data and can respond to data transactions by the one or more server nodes 104 so that the storage devices 110 appear to be directly connected (i.e., local) to the server nodes 104. For example, the storage node 102a may include one or more storage devices 110a and the storage node 102b may include one or more storage devices 110b. In various examples, the storage devices 110 include HDDs, SSDs, and/or any other suitable volatile or non-volatile data storage medium. In some examples, the storage devices 110 are relatively homogeneous (e.g., having the same manufacturer, model, configuration, or a combination thereof). However, in other example, one or both of the storage node 102a and the storage node 102b may alternatively include a heterogeneous set of storage devices 110a or a heterogeneous set of storage device 110b, respectively, that includes storage devices of different media types from different manufacturers with notably different performance.

The storage devices 110 in each of the storage nodes 102 are in communication with one or more storage controllers 108. In one or more examples, the storage devices 110a of the storage node 102a are in communication with the storage controller 108a, while the storage devices 110b of the storage node 102b are in communication with the storage controller 108b. While a single storage controller (e.g., 108a, 108b) is shown inside each of the storage node 102a and 102b, respectively, it is understood that one or more storage controllers may be present within each of the storage nodes 102a and 102b.

The storage controllers 108 exercise low-level control over the storage devices 110 in order to perform data transactions on behalf of the server nodes 104, and in so doing, may group the storage devices 110 for speed and/or redundancy using a protocol such as RAID (Redundant Array of Independent/Inexpensive Disks). The grouping protocol may also provide virtualization of the grouped storage devices 110. At a high level, virtualization includes mapping physical addresses of the storage devices 110 into a virtual address space and presenting the virtual address space to the server nodes 104, other storage nodes 102, and other requestors. Accordingly, each of the storage nodes 102 may represent a group of storage devices as a volume. A requestor can therefore access data within a volume without concern for how it is distributed among the underlying storage devices 110.

The distributed storage system 101 may group the storage devices 110 for speed and/or redundancy using a virtualization technique such as RAID or disk pooling (that may utilize a RAID level). The storage controllers 108a and 108b are illustrative only; more or fewer may be used in various examples. In some cases, the distributed storage system 101 may also be communicatively coupled to a user display for displaying diagnostic information, application output, and/or other suitable data.

With respect to the distributed server node system 103, each of the one or more server nodes 104 includes any computing resource that is operable to communicate with the distributed storage system 101, such as by providing server node read requests and server node write requests to the distributed storage system 101. In one or more examples, each of the server nodes 104 is a physical server. In one or more examples, each of the server nodes 104 includes one or more host bus adapters (HBA) 116 in communication with the distributed storage system 101. The HBA 116 may provide, for example, an interface for communicating with the storage controllers 108 of the distributed storage system 101, and in that regard, may conform to any suitable hardware and/or software protocol. In various examples, the HBAs 116 include Serial Attached SCSI (SAS), iSCSI, InfiniBand®, Fibre Channel, and/or Fibre Channel over Ethernet (FCoE) bus adapters. Other suitable protocols include SATA, eSATA, PATA, USB, and FireWire.

The HBAs 116 of the server nodes 104 may be coupled to the distributed storage system 101 by a network 118 comprising any number of wired communications links, wireless communications links, optical communications links, or combination thereof. For example, the network 118 may include a direct connection (e.g., a single wire or other point-to-point connection), a networked connection, or any combination thereof. Examples of suitable network architectures for the network 118 include a LAN, an Ethernet subnet, a PCI or PCIe subnet, a switched PCIe subnet, a WAN, a MAN, the Internet, Fibre Channel, or the like. In many examples, a server node 104 may have multiple communications links with a single distributed storage system 101 for redundancy. The multiple links may be provided by a single HBA 116 or multiple HBAs 116 within the server nodes 104. In some examples, the multiple links operate in parallel to increase bandwidth.

In one or more examples, each of the server nodes 104 may have another HBA that is used for communication with the computing system 105 over the network 106. In other examples, each of the server nodes 104 may have some other type of adapter or interface for communication with the computing system 105 over the network 106.

To interact with (e.g., write, read, modify, etc.) remote data, a HBA 116 sends one or more data transactions to the distributed storage system 101. Data transactions are requests to write, read, or otherwise access data stored within a volume in the distributed storage system 101, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The distributed storage system 101 executes the data transactions on behalf of the server nodes 104 by writing, reading, or otherwise accessing data on the relevant storage devices 110. A distributed storage system 101 may also execute data transactions based on applications running on the distributed server node system 103. For some data transactions, the distributed storage system 101 formulates a response that may include requested data, status indicators, error messages, and/or other suitable data and provides the response to the provider of the transaction.

In one or more examples, an orchestration engine 120 is run on the distributed server node system 103. The orchestration engine 120 may run on one or more of the server nodes 104 in the distributed server node system 103. The orchestration engine 120 is a container orchestration engine that enables file system services for parallel file systems to be run in containers and volumes to be mounted from the distributed storage system 101 to the distributed server node system 103. The orchestration engine 120 is described in greater detail below.

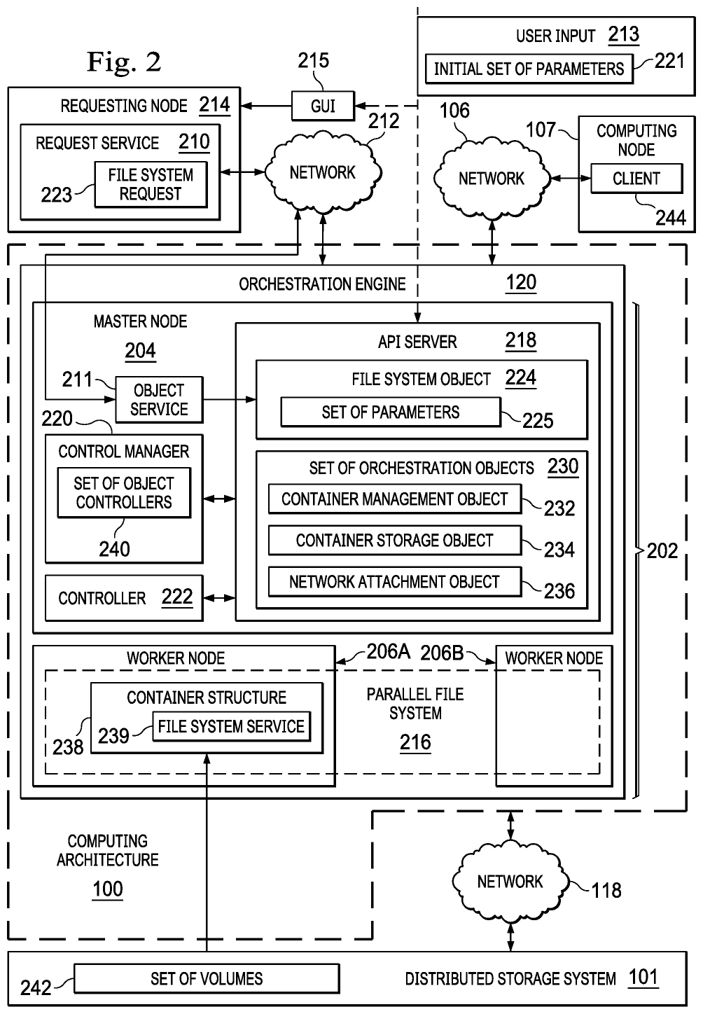

FIG. 2 is a schematic diagram illustrating the orchestration engine 120 of the computing architecture 100 from FIG. 1 in greater detail in accordance with one or more example embodiments. The orchestration engine 120 is used to manage or run parallel file systems. For example, the orchestration engine 120 is used to automatically configure, create, and modify (including delete) parallel file systems that provide access to the data stored in volumes within the distributed storage system 101. More particularly, the orchestration engine 120 is a container orchestration engine that enables automating the deployment, scaling, and management of containerized applications.

The orchestration engine 120 may be implemented over a single node or a cluster of nodes 202. In one or more examples, the cluster of nodes 202 is distributed across at least a portion of the distributed server node system 103 described in FIG. 1. For example, each node in the cluster of nodes 202 may be a different one of the server nodes 104 in the distributed server node system 103. More particularly, in one or more examples, each node in the cluster of nodes 202 is a different physical server of the distributed server node system 103. In other examples, two or more nodes in the cluster of nodes 202 may be run on a same physical server. In still other examples, one or more nodes may be run across multiple server nodes 104 such that, for example, a node in the cluster of nodes 202 is distributed across a plurality of physical servers.

The cluster of nodes 202 includes at least one master node 204 and a number of worker nodes 206 (e.g., worker node 206a, worker node 206b) in communication with the master node 204. While a single master node 204 is shown and described below, it should be understood that multiple master nodes 204 may be used in other examples. While two of the worker nodes 206 (e.g., 206a and 206b) are shown, it is understood that the cluster of nodes 202 may include any number of worker nodes 206 in communication with the master node 204. For example, the cluster of nodes 202 may include a single worker node, three worker nodes, five worker nodes, or some other number of worker nodes. In other examples, the orchestration engine 120 may be implemented using a single node that performs the functions of the master node 204 and the one or more worker nodes 206 described below. The master node 204 controls the one or more worker nodes 206. The one or more worker nodes 206 may start and stop containers on demand and ensure that any active container is healthy. Each active container may be running a service, for example, that holds a running application, libraries, and their dependencies.

The cluster of nodes 202 is in communication with the distributed storage system 101 via the network 118. The network 118 may be comprised of any number of wired communications links, wireless communications links, optical communications links, or combination thereof that enables communications between the cluster of nodes 202 and the distributed storage system 101. In one or more examples, the network 118 includes a network of fibre channels (FC) connected via a fibre channel switch for enabling communications between the distributed storage system 101 and the cluster of nodes 202.

Further, the cluster of nodes 202 may be in communications with one or more services that are either considered part of the computing architecture 100 or in communication with the computing architecture 100 via a network 212. The network 212 may be comprised of any number of wired communications links, wireless communications links, optical communications links, or combination thereof that enables communications between the orchestration engine 120 and the one or more services. These one or more services may include, for example, a request service 210 and an object service 211. The request service 210, which may run on a requesting node 214, may be in direct and/or indirect communication with the orchestration engine 120 over the network 212. The requesting node 214 may be a computing device such as, for example, without limitation, a computer, a laptop, a tablet, a smart phone, a server, or some other type of computing device. The object service 211 may be in direct or indirect communication with the request service 210 and the orchestration engine 120. The object service 211 may run on the requesting node 214, the master node 204, a server node within the distributed server node system 103, or some other computing node outside the computing architecture 100. In FIG. 2, the object service 211 is shown implemented within the master node 204.

In some examples, the request service 210 may also be in communication with a graphical user interface (GUI) 215 over a different network than network 212. In other examples, however, this communication may be over network 212. In some examples, the requesting node 214 may host the graphical user interface 215. In other examples the graphical user interface 215 may be hosted by another computing node. In one or more examples, an end user may provide user input 213 to the request service 210 either directly or indirectly via the graphical user interface 215. The user input 213 may be used in the creation or modification of a parallel file system 216.

The orchestration engine 120 has a control plane that includes an application programming interface (API) server 218, a control manager 220, and a controller 222, all of which may be deployed on the master node 204. The API server 218 exposes an API of the orchestration engine 120. More particularly, the API server 218 exposes the API of the orchestration engine 120 to the object service 211 (master node 204) and/or to the request service 210 (requesting node 214) directly or indirectly. In other words, the API server 218 may be the front end of the control plane of the orchestration engine 120. The control manager 220 manages various control or controller processes in the control plane of the orchestration engine 120 that, for example, monitor nodes, manage replication, manage the scope of containers, services, and deployments, manage authentication of requests, perform other types of management or control functions, or a combination thereof.

In one or more embodiments, the orchestration engine 120 is implemented using Kubernetes®, which is an open-source system for managing containerized applications. More particularly, Kubernetes® aids in the management of containerized applications across a group of machines (e.g., virtual machines). When the orchestration engine 120 is implemented using Kubernetes®, the controller 222 may be a custom file system (FS) controller that is added to Kubernetes® to adapt Kubernetes® for creating, mounting, modifying (including deleting) containerized parallel file systems on demand. The controller 222 may comprise, for example, software that is executed on the master node 204.

The controller 222 enables automation of the configuration, creation, and modification (which includes deletion) of parallel file systems in a manner that simplifies the knowledge needed by the end user to configure, create, and modify, respectively, a parallel file system. Further, the controller 222 may reduce the overall time and resources needed to configure, create, and modify efficient parallel file systems that are tuned to the needs of an end user based on requests received either indirectly or directly from the request service 210 or based on user input 213 received directly by the API server 218. The controller 222 operates on the master node 204 to improve the functioning of the master node 204 and overall control of the worker nodes 206 by the master node 204.

The controller 222 monitors the API server 218 for the presence of objects on the API server 218 and can detect when a file system object 224 has been written onto the API server 218. This file system object 224 may be received at the API server 218 from a source that may take a number of different forms. For example, the source may be the request service 210, the object service 211, or the user input 213. In some cases, the file system object 224 may be received at the source from a different provider or generated by the source in response to input received at the source from the different provider. As one example, the source may be the object service 211, with the object service 211 generating the file system object 224 based on input received from the request service 210.

In one or more examples, an end user (e.g., a customer) provides the user input 213 to the request service 210 via the graphical user interface 215. The end user may access the graphical user interface 215 through, for example, a web browser running on a computing node. The user input 213 identifies a value for each parameter of an initial set of parameters 221 for the parallel file system 216. The initial set of parameters 221 includes one or more parameters. The graphical user interface 215 issues a file system request 223 (e.g., a web API request) to the request service 210 based on this user input 213 in which the file system request 223 includes the initial set of parameters 221.

In one or more examples, the graphical user interface 215 may be accessed by a web browser running on a computing node in communication with the network 212 such that the file system request 223 may be sent to the request service 210 over the network 212. In some examples, the graphical user interface 215 may send the file system request 223 to request service 210 over a different network. In some examples, the requesting node 214 may host the graphical user interface 215. In other examples, the graphical user interface 215 may be hosted by the computing node 107 with the computing node 107 configured for communication over the network 212 such that the graphical user interface 215 can send the file system request 223 to the request service 210 over the network 212. In still other examples the graphical user interface 215 may be hosted by another computing node. In yet other examples, rather than interacting with the graphical user interface 215, the end user may interact directly with the request service 210 to create the file system request 223. Thus, the file system request 223 may be received at the request service 210 in any of a number of different ways.

In some cases, the request service 210 translates and forwards the file system request 223 to the object service 211. For example, the request service 210 may translate the file system request 223 to convert the file system request 223 from one type of API request to another type of API request that is supported by the object service 211. The object service 211 may then translate this translated file system request 223 and convert the translated file system request 223 into a file system object 224 with a set of parameters 225. This set of parameters 225 may include the initial set of parameters 221 and optionally one or more additional parameters. For example, the object service 211 may add one or more parameters to the initial set of parameters 221 to form the set of parameters 225. In other examples, the request service 210 may add one or more parameters to the initial set of parameters 221 to form the set of parameters 225 prior to the file system request 223 being sent to the object service 211. In yet other examples, one or more other services along a communication path to the API server 218 that includes the request service 210 and the object service 211 may add the one or more parameters to the initial set of parameters 221 to form the set of parameters 225. The object service 211 then writes the file system object 224 onto the API server 218. In other cases, the request service 210 translates the file system request 223 and converts the file system request 223 into the file system object 224 with the set of parameters 225. The request service 210 then directly sends the file system object 224 to the API server 218.

The set of parameters 225 is specific to the parallel file system 216 that is to be created or modified. The set of parameters 225 may include, for example, at least one of a name for the parallel file system 216, a capacity for the parallel file system 216, a subnetwork (e.g., a single IP address or range of IP addresses) for the parallel file system 216, a subnetwork partition (e.g., a designated VLAN) for the parallel file system, one or more other types of parameters relating to the parallel file system 216, or a combination thereof. In one or more examples, the subnetwork partition is added as a parameter by the object service 211, the request service 210, or another service along a communication path to the API server 218 that includes the request service 210 and the object service 211. The orchestration engine 120 is configured to easily and efficiently automate the configuration, creation, and modification of parallel file systems with relatively few parameters (e.g., one or more parameters) included in the set of parameters 225. The file system object 224 received at the API server 218 may be a new file system object or a modified file system object identifying the set of parameters 225. When the orchestration engine 120 is implemented using Kubernetes®, the file system object 224 may be referred to as a custom resource (CR) object that identifies the set of parameters 225.

In one or more other examples, the user input 213 is received directly at the API server 218 for uploading the file system object 224 onto the API server 218. In one or more examples, this user input 213 may be received at the API server 218 over a network other than the network 212 and the network 106. In these one or more examples, the initial set of parameters 221 provided by the user input 213 forms the set of parameters 225 for the file system object 224. Thus, the file system 224 may arrive at or be written onto the API server 218 via a communication path that includes the user input 213, the graphical user interface 215, the request service 210, the object service 211, one or more other services, or a combination thereof.

As discussed above, the controller 222 monitors the API server 218 for the presence of file system objects on the API server 218 and can detect when a file system object, such as the file system object 224, has been written onto the API server 218. For example, the controller 222 may assess periodically (e.g., at the lapse of a periodic event such as the lapse of a regular interval) whether any file system objects have been written to the API server 218. In one or more examples, the controller 222 searches for file system objects every 1 second, 3 seconds, 5 seconds, 1 minute, 5 minutes, or other interval. In other examples, the controller 222 may continuously monitor the API server 218 for file system objects.

When the controller 222 detects the file system object 224, the controller 222 processes the file system object 224 and automatically creates at least one set of orchestration objects 230 for the parallel file system 216 based on the set of parameters 225 identified in the file system object 224. In one or more examples, the controller 222 uses a number of templates, a number of algorithms, preprogrammed instructions, or a combination thereof to build the at least one set of orchestration objects 230 based on the set of parameters 225.

For example, the controller 222 may be programmed with a template for each orchestration object in a set of orchestration objects 230. For each orchestration object, the controller 222 may run one or more algorithms to fill out or otherwise complete the template for that orchestration object based on the set of parameters 225 (e.g., based on at least one parameter of the set of parameters). The one or more algorithms determine how many instances of each orchestration object in the set of orchestration objects 230 are to be created.

Each object in the set of orchestration objects 230 may include one or more fields such as, for example, a request, a response, a state (or status), a custom resource, a specification, one or more processes, or a combination thereof. In one or more examples, each object in the set of orchestration objects 230 includes a specification and a state (or status). The set of orchestration objects 230 may include, for example, one or more container management objects 232, one or more container storage objects 234, and one or more network attachment objects 236, one or more other types of objects, or a combination thereof.

The container management object 232 may be an API object that defines the desired characteristics for one or more container structures. A container structure may include one or more containers, which may also be referred to as a containerized application. The one or more containers in a container structure share access to network information and resources and are configured to run on a same one of the worker nodes 206. In one or more examples, the one or more containers in a container structure are configured to run on a same server node of the server nodes 104 (e.g., a same physical server). In one or more examples, when the orchestration engine 120 is implemented using Kubernetes®, a container structure is also referred to as a pod. For example, when the orchestration engine 120 takes the form of Kubernetes®, the container management object 232 describes the desired characteristics for one or more pods, each of the pods comprising one or more containers. This API object may be referred to as a “statefulset” object. The container management object 232 specifies the deployment and scaling of the one or more container structures (e.g., the one or more pods). The container management object 232 ensures proper mapping between the one or more container structures and the volumes of storage in the distributed storage system 101 used for those one or more container structures.

The container storage object 234 is an object that requests a certain amount of storage be allocated for use by the one or more container structures specified by the container management object 232. For example, the container storage object 234 may request a specific number of persistent volumes, with each persistent volume being a piece of storage that is provisioned for the one or more container structures (e.g., pods) for the parallel file system 216, having a particular size, and having particular identifying characteristics. When the orchestration engine 120 takes the form of Kubernetes®, the container storage object 234 may be referred to as a “persistentvolumeclaim” object.

The network attachment object 236 is an object that sets up a network for the one or more container structures (e.g., pods) specified by the container management object 232. For example, the orchestration engine 120 may be preconfigured with network interfaces capable of isolating the input/output traffic into the one or more pods that will form the parallel file system 216 from other pods and file systems. The network attachment object 236 specifies the particular network interface for the one or more pods. In one or more examples, the orchestration engine 120 includes single root input/output virtualization (SR-IOV) and/or remote direct memory access (RDMA) Ethernet interfaces that can be used to isolate the input/output traffic for the various pods. When the orchestration engine 120 takes the form of Kubernetes®, the network attachment object 236 may be referred to as a “networkattachmentdefinition” object.

The controller 222 creates the set of orchestration objects 230 in a format that is readable by the orchestration engine 120 in a manner that may reduce or minimize any additional processing or modification. For example, when the orchestration engine 120 is Kubernetes®, the controller 222 creates the set of orchestration objects 230 in a format native to Kubernetes® that Kubernetes® can readily understand and utilize. Thus, the controller 222 bears the burden of taking the set of parameters 225 identified in the file system object 224 and automatically generating the set of orchestration objects 230, and in some examples, without the end user using the graphical user interface 215 or the request service 210 being aware of or interacting directly with the orchestration engine 120 for this purpose. In other words, in some examples, complexity is shifted away from the end user (e.g., the customer), with the end user only providing the initial set of parameters 221 (i.e., a few basic fields) that are included in the file system object 224. Of course, other embodiments may allow for additional user input.

The controller 222 sends the set of orchestration objects 230 to the API server 218. The control manager 220 of the orchestration engine 120 runs one or more processes based on the set of orchestration objects 230 on the API server 218 and configures at least one container structure 238 using the set of orchestration objects 230. More particularly, the control manager 220 may include a set of object controllers 240 used to configure the container structure 238. Each object controller of the set of object controllers 240 may comprise, for example, software executed on the master node 204 for configuring one or more container structures. More particularly, each object controller in the set of object controllers 240 runs one or more processes based on a corresponding one or more orchestration objects of the set of orchestration objects 230 to configure the container structure 238. For example, the set of object controllers 240 may include at least one of a container management controller for creating the container structure 238 based on the container management object 232; a volume controller for identifying and assigning one or more volumes of storage to the container structure 238 based on the container storage object 234; a network attachment controller for assigning a subnetwork, and in some cases a subnetwork partition, to the container structure 238 based on the network attachment object 236; or some other type of object controller. In other examples, the set of object controllers 240 may operate as part of the orchestration engine 120 but separate from the control manager 220.

The container structure 238 is assigned to one of the worker nodes 206 associated with the orchestration engine 120. For example, the container structure 238 may be assigned to the worker node 206a. The container structure 238 includes one or more containers. In some cases, the container structure 238 is referred to as a “pod.” The parallel file system 216 may be run using any number of container structures, each of the container structures running a different service (e.g., a file system service). For example, the container structure 238 may be used to run a file system service 239. The file system service 239 may be, for example, a management service, a metadata service, a storage service, or another type of file system service. In one or more examples, the parallel file system 216 is run using a container structure for each of the management service, at least one metadata service, and at least one storage service.

When the container structure 238 is a preexisting container structure, the orchestration engine 120 modifies the container structure 238 as needed based on the set of orchestration objects 230. When the container structure 238 is a new container structure, the orchestration engine 120 allocates a “share” of memory resources and processing (e.g., central processing unit (CPU)) resources to create the container structure 238. Modifying a container structure such as the container structure 238 may include modifying the resources employed by the container structure 238, deleting the container structure 238, some other type of modification operation, or a combination thereof.

In one or more examples, the container structure 238 is assigned to a selected one of the worker nodes 206 (e.g., worker node 206a, worker node 206b). The orchestration engine 120 mounts a set of volumes 242 in the distributed storage system 101 to the selected one of the worker nodes 206. The set of volumes 242 may be located on a single storage node (e.g., storage node 102a of FIG. 1) or distributed across multiple storage nodes (e.g., storage node 102a and storage node 102b of FIG. 1) in the distributed storage system 101. In this manner, the orchestration engine 120 uses the set of orchestration objects 230 to configure any number of container structures (e.g., 238) to run the parallel file system 216. The orchestration engine 120 mounts (e.g., assigns and exposes) a corresponding set of volumes in the distributed storage system 101 to each of these container structures.

The orchestration engine 120 tracks the worker nodes 206 and monitors the pressure placed on memory and processing resources and works to schedule services in a balanced manner. With respect to the worker nodes 206, one or more container structures 238 may run on a same one of the worker nodes 206. And any number of parallel file systems similar to the parallel file system 216 may be run by the worker nodes 206. For example, multiple container structures for multiple tenants (e.g., customers) may be run on a single worker node. Similarly, the file system services for multiple parallel file systems that belong to different tenants (or customers) may be run on a single worker node. The orchestration engine 120 provides network isolation such that the container structures corresponding to one tenant (e.g., customer) may be assigned to at least one subnetwork, and in some cases, subnetwork partition (e.g., VLAN), that is distinct and isolated from the subnetwork, or subnetwork partition, used by another tenant.

As one example, the one or more parallel file systems for a first customer may be assigned to a first range of IP addresses, while the one or more parallel file systems for a second customer may be assigned to a second range of IP addresses that is different from the first range of IP addresses so that access between the customers does not overlap or conflict. In some cases, each file system service of a parallel file system may be addressable on its own IP address within a range of IP addresses designated for that parallel file system. In another example, a parallel file system for a first customer may be assigned to a VLAN associated with a particular range of IP addresses, while the parallel file system for a second customer may be assigned to a different VLAN associated with at the same range of IP addresses, thereby ensuring isolation. In this manner, input/output traffic for the various container structures belonging to a tenant on the different worker nodes may be isolated and accessible via a separate corresponding subnetwork (e.g., a single or range of IP addresses) or subnetwork partition (e.g., VLAN).

An end user may use a client 244 to mount and use the parallel file system 216 that is orchestrated by the orchestration engine 120. The computing node 107 described in FIG. 1 may include, for example, the client 244. The client 244 may be, for example, a parallel file system client service (e.g., BeeGFS® client service) running on any number of computing devices to mount one or more parallel file systems running on the distributed server node system 103. The client 244 may be aware of the management, metadata, and storage services that serve, for example, the parallel file system 216 but is left unaware that these services for the parallel file system 216 are being run via container structures, such as the container structure 238.

As one example, the client 244 may communicate with the file system service 239 running within the container structure 238 on the worker node 206a via a VLAN in the network 106 as described above. In one or more examples, the client 244 may be one of multiple clients communicating with different file system services running in different container structures on the same worker node 206a, with each client of these multiple clients communicating with one or more corresponding file system services over a different and unique VLAN. In some examples, the client 244 may be one client out of multiple clients belonging to or used by a first customer. The VLAN used for this particular customer may be different from the VLAN used for a second customer to ensure that the first customer's clients are unable to access the one or more parallel file systems of the second customer. This ensures that each client's access to a parallel file system is isolated.

As one specific example, an end user at the client 244 may mount (e.g., establish communication with one or more container structures of) the parallel file system 216 managed by the orchestration engine 120 that provides access to the data in one or more volumes in the distributed storage system 101. For example, when the client 244 “mounts” the parallel file system 216, the client 244 may establish communications with the file system service 239 running in the container structure 238, which, in turn, provides access to the data in one or more corresponding volumes in the distributed storage system 101. Another end user at the client 244 or a similar client may use the computing architecture 100 to similarly mount a different parallel file system that provides access to the data in one or more other volumes in the distributed storage system 101. The one or more container structures 238 used for the parallel file system 216 and the one or more container structures 238 used for the other parallel file system may run on different worker nodes 206 or the same worker node. In one example, the two parallel file systems may be run using the same hardware (e.g., the worker nodes 206) but the input/output traffic for each of the two parallel file systems is isolated due to the different subnetwork partitions such that neither end user is aware of any overlap in hardware. Thus, the orchestration engine 120 functions as a “black box” that can provision and modify (including delete) parallel file systems without the end user having any special knowledge about the orchestration engine 120 or the underlying hardware used to host the parallel file systems.

The orchestration engine 120 enables parallel file systems to be set up with high availability. High availability ensures that the container structures for the various parallel file systems operate with a predetermined level of operational performance (e.g., at least 98% or 99% uptime). High availability may also ensure that the orchestration engine provides redundancy to help accommodate for points of failure (e.g., single points of failure). In one or more examples, if one of the worker nodes 206, such as worker node 206a, is shut down by an administrator, the orchestration engine 120 automatically migrates the one or more container structures, such as container structure 238, running on that worker node 206a to another worker node, such as worker node 206b. This migration reduces the downtime and data loss associated with these one or more container structures. In other examples, the orchestration engine 120 may monitor the health of the worker nodes 206 over time and may migrate container structures in a manner similar to as described above when a worker node is determined to be unhealthy (e.g., not functioning in a desired manner, failing, experiencing a loss of communication/networking capabilities, etc.) or does not meet selected performance criteria. This type of migration helps to reduce downtime and data loss associated with these file system services. Further, the data backing each file system service is also highly available because the distributed storage system 101 is highly available. Additionally, the type of migration described above may also be implemented with the master node 204. For example, if the master node 204 is shut down by an administrator or deemed to be unhealthy, at least a portion of the orchestration engine 120 may be migrated to another master node.

With respect to FIGS. 1 and 2, these illustrations are not meant to imply physical or architectural limitations to the manner in which an example embodiment may be implemented. Other components in addition to or in place of the ones illustrated may be used. Some components may be optional. Further, the blocks may be presented to illustrate some functional components. One or more of these blocks may be combined, divided, or combined and divided into different blocks when implemented in an example embodiment. Further, additional or alternative data paths/flows (e.g., communications links between nodes and networks) may be present in other example embodiments.

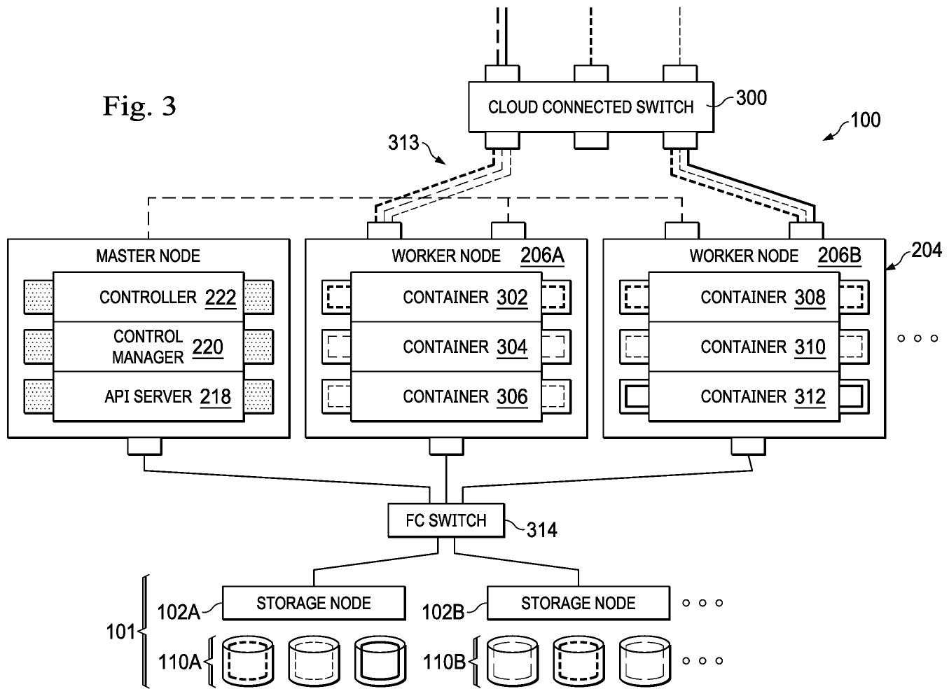

FIG. 3 is a schematic diagram of the computing architecture 100 in accordance with one or more example embodiments. The master node 204 commands and controls the worker nodes 206, each of which has been assigned to run container structures (e.g., of which container structures 238 of FIG. 2 are examples). As illustrated, the worker node 206a is assigned a container structure 302, a container structure 304, and a container structure 306, each of which belongs to a different customer. The worker node 206b is assigned a container structure 308, a container structure 310, and a container structure 312, each of which belongs to a different customer. The container structure 302 and container structure 308 may belong to a first customer. The container structure 306 and container structure 310 may belong to a different customer. In fact, customer ownership may be mixed across the worker nodes 206a and 206b. The input/output traffic for each different customer's one or more container structures may be isolated from other customers' input/output traffic. For example, customers may access the container structures on the worker nodes 206 over distinct virtual local area networks 313 via one or more cloud-connected switches 300. In some examples, multiple cloud-connected switches 300 are configured with fault-tolerant connectivity so that the failure of one of the cloud-connected switches 300 does not compromise the availability of the parallel file systems. In other words, each customer may access his or her corresponding container structures via a distinct virtual local area network managed by the cloud-connected switch 300.

For example, the computing node 107, which may include the client 244 in FIG. 2, running on the computing system 105 described with respect to FIG. 1 may access the container structures on the worker nodes 206, and the container structures may access the corresponding data stored in the distributed storage system 101. The computing node 107 may connect to the worker nodes 206 via the cloud-connected switch 300. The computing system 105 may be located remotely with respect to the worker nodes 206 or may be physically adjacent to one or more of the worker nodes 206. In some cases, locating the computing system 105 physically adjacent to the worker nodes 206 may improve (e.g., speed up) performance.

The master node 204 and the worker nodes 206 are connected to the distributed storage system 101 via one or more fibre channel switches 314 that enables efficient mounting of one or more volumes of storage to each of the container structures running on the worker nodes 206. For example, a fibre channel switch 314 provides access to the storage nodes 102a and 102b, each of which includes storage devices 110. Of course, the scope of embodiments is not limited to fibre channel, as any other networking technology may be used as appropriate. In some examples, multiple fibre channel switches 314 are configured with fault-tolerant connectivity so that the failure of one of the fibre channel switches does not compromise the availability of the parallel file systems. In one example, each of the storage devices 110a and each of the storage devices 110b may store data and metadata for one or more volumes mounted to a corresponding container structure on a worker node. As illustrated, the one or more volumes mounted to a particular container structure may be distributed across the distributed storage system 101 in a number of different ways.

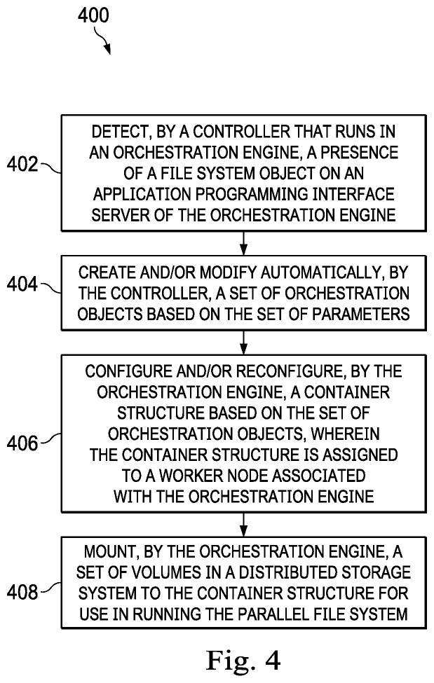

FIG. 4 is a flow diagram of a process 400 for creating and/or modifying a parallel file system in accordance with one or more example embodiments. The process 400 may be implemented by a distributed server node system running the orchestration engine and executing computer-readable instructions from one or more computer-readable media to perform the functions described herein. The process 400 may be implemented using an orchestration engine such as, for example, the orchestration engine 120 described in connection with FIGS. 1 and 2. It is understood that additional steps can be provided before, during, and after the steps of the process 400, and that some of the steps described can be replaced or eliminated in other embodiments of the process 400. The process 400 may be used to create and/or modify a container structure for a parallel file system.

The process 400 may begin by, for example, detecting, by a controller that runs in the orchestration engine, a presence of a file system object on an application programming interface server of the orchestration engine (operation 402). The file system object includes a set of parameters for a parallel file system. The set of parameters may be a basic set of parameters that includes, for example, but is not limited to, a name for the parallel file system, a capacity for the parallel file system, a subnetwork for the parallel file system, a subnetwork partition for the parallel file system, some other type of parameter, or a combination thereof. With respect to operation 402, the file system object may be written onto the API server in any of a number of different ways. More particularly, the file system object may arrive at the API server via a communication path that includes, for example, the user input 213 in FIG. 2, the graphical user interface 215 in FIG. 2, the request service 210 in FIG. 2, the object service 211 in FIG. 2, one or more other services, or a combination thereof. In some examples, the file system object may be associated with a request to create the parallel file system. But in other examples, the file system object may be associated with a request to modify the parallel file system.

The controller automatically creates and/or modifies a set of orchestration objects based on the set of parameters (operation 404). In one or more examples, the set of orchestration objects may include, for example, a container management object, a container storage object, and a network attachment object. The controller may, for example, run one or more algorithms that use the set of parameters to automatically fill out a set of templates for the set of orchestration objects.

A container structure is configured and/or reconfigured based on the set of orchestration objects (operation 406). The container structure includes one or more containers. Configuring the container structure may include, for example, assigning the container structure to a worker node associated with the orchestration engine. The worker node may include, for example, a physical server in a distributed server node system such as, for example, the distributed server node system 103 in FIG. 1. Reconfiguring the container structure may include reconfiguring (e.g., changing, adding, removing, etc.) a number of parameters/features associated with the container structure.

The orchestration engine mounts a set of volumes in a distributed storage system to the container structure for use in running the parallel file system (operation 408). Mounting the set of volumes provides an end user with indirect access to the set of volumes mounted to the container structure. For example, the end user may be able to access the parallel file system over a network via a client, with the parallel file system then providing access to the data in the set of volumes mounted to the container structure. In this manner, the parallel file system acts as an intermediary to provide the end user with indirect access to the data stored in the set of volumes. When the file system object is associated with a request to modify the parallel file system, operation 408 may be omitted in some cases. In other cases, operation 408 may be performed to mount one or more additional volumes to the container structure. In this manner, the process 400 described above may be used to create and/or modify the parallel file system.

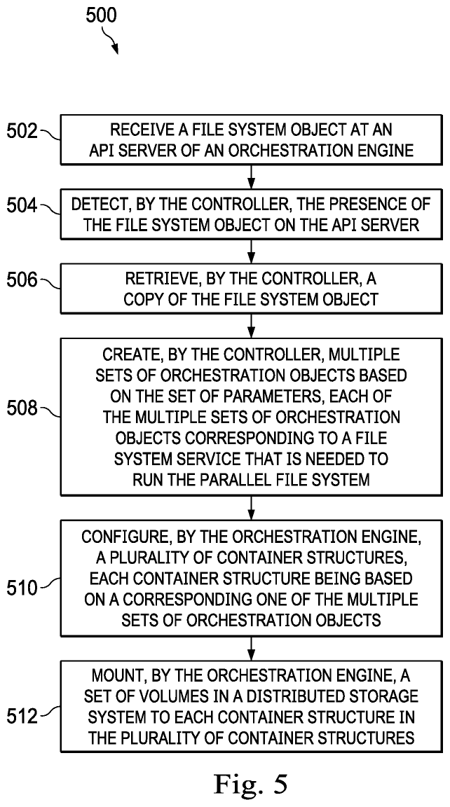

FIG. 5 is a flow diagram of a process 500 for creating a parallel file system in accordance with one or more example embodiments. The process 500 may be implemented by a distributed server node system running an orchestration engine executing computer-readable instructions from one or more computer-readable media to perform the functions described herein. The process 500 may be implemented using an orchestration engine such as, for example, the orchestration engine 120 described in connection with FIGS. 1 and 2. It is understood that additional steps can be provided before, during, and after the steps of the process 500, and that some of the steps described can be replaced or eliminated in other embodiments of the process 500. The process 500 may be a more detailed example of a manner in which the process 400 described in connection with FIG. 4 may be implemented to create a parallel file system.

The process 500 may begin by receiving a file system object at an API server of an orchestration engine (operation 502). The file system object includes a set of parameters that may include, for example, but is not limited to, a name for a parallel file system that is to be created, a capacity for that parallel file system, a subnetwork for the parallel file system, a subnetwork partition (e.g., VLAN) for the parallel file system, or a combination thereof. The file system object may be received at the API server from a source, which may take the form of user input, a request service, an object service, one or more other services, or a combination thereof. For example, the file system object may be received from an object service such as the object service 211 described in connection with FIG. 2, or a request service such as the request service 210 described in connection with FIG. 2. The set of parameters identified in the file system object may include an initial set of parameters provided by an end user via, for example, a graphical user interface such as the graphical user interface 215 described with respect to FIG. 2. In other examples, the file system object may be received at the API server via user input, such as the user input 213 described in connection with FIG. 2. In these other examples, the set of parameters is provided by this user input.

A controller detects the presence of the file system object on the API server (operation 504). The controller retrieves a copy of the file system object (operation 506). The controller then creates multiple sets of orchestration objects based on the set of parameters, each of the multiple sets of orchestration objects corresponding to a file system service that is needed to run the parallel file system (operation 508). For example, the controller may create one set of orchestration objects for a management service, one set of orchestration objects for each of one or more metadata services, and one set of orchestration objects for each of one or more storage services. The set of orchestration objects for a given file system service may include, for example, a container management object, a container storage object, and a network attachment object.

The orchestration engine then configures a plurality of container structures, each container structure being based on a corresponding one of the multiple sets of orchestration objects (operation 510). Each container structure is assigned to a worker node (e.g., a physical server). In one or more examples, all of the container structures for a parallel file system are run on one or more worker nodes. The orchestration engine mounts a set of volumes in a distributed storage system to each container structure in the plurality of container structures (operation 512). An end user, via a parallel file system client, may mount a parallel file system by establishing communication with one or more file system services of the parallel file system running in one or more container structures. These one or more file system services, in turn, provide the end user with access to the data stored in the set of volumes.

As a result of the elements discussed above, examples of the present disclosure improve upon storage system technology. For example, the orchestration engine enables a parallel file system to be easily and efficiently created, in some cases, even without the end user knowing much about the orchestration engine or the underlying hardware being used to mount the parallel file system. Further, the orchestration engine creates and runs the parallel file system such that the parallel file system has high availability. Any complexity at the backend having to do with the running of the parallel file system may be hidden from the end user (e.g., customer) such that the frontend is simplified and abstracted. The methods and systems described herein provide for reducing the overall amount of time and processing resources needed to configure, create, and modify efficient parallel file systems that are tuned to specific customer needs and needed to provide efficient multitenancy solutions.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
detecting, by an orchestration engine, a presence of a file system object received by the orchestration engine, wherein the file system object includes a set of parameters for a parallel file system;
creating, automatically by the orchestration engine, a set of orchestration objects based on the set of parameters;
configuring, by the orchestration engine, a container structure based on the set of orchestration objects; and
mounting, by the orchestration engine, a set of volumes in a distributed storage system to the container structure for use in running the parallel file system.

2. The method of claim 1, wherein the creating automatically further comprises:
creating, automatically by the orchestration engine, a container management object, a container storage object, and a network attachment object based on the set of parameters.

3. The method of claim 1, wherein the configuring further comprises:
configuring, by the orchestration engine, the container structure to run a file system service based on at least one orchestration object of the set of orchestration objects.

4. The method of claim 1, wherein the configuring further comprises:
assigning, by the orchestration engine, the container structure to a subnetwork based on a network attachment object of the set of orchestration objects to isolate input/output traffic for the container structure to the subnetwork.

5. The method of claim 1, further comprising:
receiving, by the orchestration engine, the file system object from a request service, wherein a parameter in the set of parameters identified in the file system object includes an item selected from a list consisting of a name, a capacity, and a subnetwork.

6. The method of claim 1, further comprising:
receiving, by the orchestration engine, the file system object at an application programming interface server in the orchestration engine from a source, wherein the source includes an item selected from a list consisting of user input, a request service, an object service, and another service.

7. The method of claim 1, further comprising:
establishing, by the orchestration engine, communications between a client and a file system service running within the container structure, wherein the container structure provides access to data stored in the set of volumes.

8. The method of claim 1, wherein the creating further comprises:
running, by the orchestration engine, at least one algorithm to fill out a set of templates based on the set of parameters, wherein each template of the set of templates forms a specification for a corresponding orchestration object of the set of orchestration objects.

9. A non-transitory machine-readable medium having stored thereon instructions for performing a method comprising machine executable code which, when executed by at least one machine, causes the at least one machine to:
detect a presence of a file system object on an application programming interface server, wherein the file system object includes a set of parameters for a parallel file system;
create a set of orchestration objects based on the set of parameters;
configure a container structure based on the set of orchestration objects, wherein the container structure is assigned to a worker node associated with the orchestration engine;
mount a set of volumes in a distributed storage system to the container structure for use in running the parallel file system; and
establish communications between a client and a file system service running within the container structure, wherein the container structure provides access to data stored in the set of volumes.

10. The non-transitory machine-readable medium of claim 9, wherein the at least one machine creating the set of orchestration objects comprises:
creating automatically a container management object, a container storage object, and a network attachment object based on the set of parameters.

11. The non-transitory machine-readable medium of claim 9, wherein the at least one machine configuring the container structure comprises:
configuring the container structure to run a file system service for the parallel file system based on at least one orchestration object of the set of orchestration objects.

12. The non-transitory machine-readable medium of claim 9, wherein the at least one machine configuring the container structure comprises:
assigning the container structure to a subnetwork based on a network attachment object of the set of orchestration objects to isolate input/output traffic for the container structure to the subnetwork.

13. The non-transitory machine-readable medium of claim 9, wherein the machine executable code further causes the at least one machine to:
receive the file system object at the application programming interface server from a source, wherein the source includes an item selected from a list consisting of user input, a request service, an object service, and another service.

14. The non-transitory machine-readable medium of claim 9, wherein the machine executable code further causes the at least one machine to:
receive the file system object including the set of parameters at the application programming interface server, wherein a parameter in the set of parameters identified in the file system object includes an item selected from a list consisting of a name, a capacity, a subnetwork, and a subnetwork partition for the parallel file system.

15. A computing device comprising:
a memory containing machine readable medium comprising machine executable code having stored thereon instructions for performing a method of managing a parallel file system during input/output (I/O) operation; and
a processor coupled to the at least one memory, the at least one processor configured to execute the machine executable code to cause the processor to:
detect a presence of a file system object on an application programming interface server of an orchestration engine, wherein the file system object includes a set of parameters for a parallel file system;
create automatically a set of orchestration objects based on the set of parameters;
configure a container structure based on the set of orchestration objects; and
mount a set of volumes in a distributed storage system to the container structure for use in running the parallel file system.

16. The computing device of claim 15, wherein the set of orchestration objects includes a container management object, a container storage object, and a network attachment object based on the set of parameters.

17. The computing device of claim 15, wherein configuring the container structure comprises assigning the container structure to a subnetwork and a subnetwork partition based on at least a network attachment object of the set of orchestration objects to isolate input/output traffic for the container structure to the subnetwork partition.

18. The computing device of claim 15, wherein a parameter in the set of parameters identified in the file system object includes an item selected from a list consisting of a name, a capacity, a subnetwork, and a subnetwork partition for the parallel file system.

19. The computing device of claim 15, wherein at least one algorithm is run to fill out a set of templates based on the set of parameters in which each template of the set of templates forms a specification for a corresponding orchestration object of the set of orchestration objects.

20. The computing device of claim 15, wherein configuring the container structure comprises assigning the container structure to a worker node associated with the orchestration engine.
